(19) United States
(12) Patent Application Publication
(10) Pub. No.: US 2010/0126190 A1
(43) Pub. Date: May 27, 2010

(54) AIR-CLEANING DEVICE FOR EVAPORATOR OF VEHICLE AND CONTROL METHOD

(76) Inventor: Chi Kook Ha, Yangpyeong-gun (KR)

Correspondence Address: Jefferson IP Law, LLP, 1130 Connecticut Ave., NW, Suite 420, Washington, DC, 20036, US

(21) Appl. No.: 12/593,732

(22) PCT Filed: Feb. 21, 2008
(86) PCT No.: PCT/KR2008/001004

§ 371 Date: Sep. 29, 2009

(30) Foreign Application Priority Data
Apr. 12, 2007 (KR) 10-2007-0035876
Feb. 14, 2008 (KR) 10-2008-0013330

(51) Int. Cl. B60H 1/00; F25B 43/00

(52) U.S. Cl. 62/78; 62/195

(57) ABSTRACT

An apparatus is disclosed which sterilizes an evaporator of an automotive HVAC system depending on whether the vehicle engine starts. The apparatus comprises: an engine start detector (160) tor detecting whether a vehicle engine starts as the engine start detector is connected to a power line, ignition-1, necessary for the engine start up: an ultraviolet lamp (130) that is installed adjacent to the evaporator and supplied with power output from a vehicle battery (70); a temperature sensor (140) installed adjacent to the evaporator (50) for sensing the temperature of the evaporator (50); a mode selection switch (150) for setting an automatic mode in which the UV lamp (130) is turned on/off or a continuous mode in which the UV lamp (130) is continuously turned on, according to the temperature of the evaporator (50) sensed by the temperature sensor (140), and a controller (110) for controlling the turning on/off of the UV lamp (130) according to the mode set by the mode selection switch (150), after the engine start detector detects the vehicle start-up, wherein the controller (110) turns on/off the UV lamp (130) according to temperature changes of the surface of the evaporator (50), sensed by the temperature sensor (140), when the mode is set to the automatic mode, and continuously turns on the UV lamp (130) when the mode is set to the continuous mode.

### TECHNICAL FIELD

The present invention relates to an automotive heating, ventilating and air-conditioning (HVAC) system. More particularly, this invention relates to an apparatus that can sterilize an evaporator included in an automotive HVAC system using an ultraviolet (UV) lamp, so that pleasant air can be provided to the passenger compartment of the vehicle, and to a control method of the apparatus.

### BACKGROUND ART

In general, automotive HVAC systems serve to heat/cool the passenger compartment for a driver and passengers or to remove fog or frost from the windshield for safe driving. The automotive HVAC system includes a cooling unit and a heating unit. The automotive HVAC system selectively receives outside air and inside air and heats or cools the air, so that the heated or cooled air can be blown into the passenger compartment. The cooling unit of the conventional automotive HVAC system includes an evaporator for generating cooled air. When the cooling unit is operated, the evaporator picks up the heat from ambient air thereof, and accordingly water droplets are formed on the surface of the evaporator due to the temperature difference between the evaporator and the ambient air. The water droplets cause the surface of the evaporator to become wet. While the cooling unit of a vehicle is operated, undesirable airborne matter from the outside air may become attached to the water droplets on the surface of the evaporator. In that case, mold and bacteria, etc. may form and multiply on the wet surface of the evaporator, resulting in odorous air being transmitted to the passenger compartment which in turn creates an unpleasant and potentially harmful atmosphere for passengers.

### DISCLOSURE OF INVENTION

### Technical Problem

The present invention solves the above problems and provides an apparatus that can sterilize an evaporator of an automotive heating, ventilating, and air conditioning (HVAC) system, on which mold and bacteria may multiply and grow, using an ultraviolet (UV) lamp and can supply the purified air to the passenger compartment of a vehicle. Also, the present invention provides a control method of the apparatus for sterilizing an evaporator of an automotive HVAC system.

The present invention further provides an apparatus for sterilizing an evaporator of an automotive HVAC system that can efficiently operates a UV lamp according to the conditions of the evaporator. Also, the present invention provides a control method of the apparatus.

The present invention further provides an apparatus for sterilizing an evaporator of an automotive HVAC system, which can indicate whether a UV lamp is operated and can inform the user when the UV lamp needs replacing, so that the user can easily be aware of the state of the UV lamp. Also, the present invention provides a control method of the apparatus.

### Technical Solution

In accordance with an exemplary embodiment of the present invention, the present invention provides an apparatus for sterilizing an evaporator of an automotive heating, ventilating and air-conditioning (HVAC) system depending on whether vehicle engine starts. The apparatus includes: an engine start detector for detecting whether a vehicle engine starts as the engine start detector is connected to a power line of ignition-1 (IG-1) necessary for the engine start up; an ultraviolet (UV) lamp that is installed adjacent to the evaporator and supplied with power output from a vehicle battery; a temperature sensor installed adjacent to the evaporator for sensing the temperature of evaporator; a mode selection switch for setting an automatic mode in which the UV lamp is turned on/off or a continuous mode in which the UV lamp is continuously turned on, according to the temperature of the evaporator sensed by the temperature sensor; and a controller for controlling the turn on/off of the UV lamp according to the mode set by the mode selection switch, after the engine start detector detects the vehicle start-up, wherein the controller turns on/off the UV lamp according to temperature changes of the surface of the evaporator, sensed by the temperature sensor, when the mode is set to the automatic mode, and continuously turns on the UV lamp when the mode is set to the continuous mode.

Preferably, the apparatus further includes: a timer for measuring the vehicle operating time when the engine start detector detects the engine starting. Here, the controller turns on the UV lamp for a set time with operation of the timer, and turns on/off the UV lamp according to the mode set by the mode selection switch after the set time has elapsed.

Preferably, the controller continuously turns on the UV lamp when the temperature of the periphery of the evaporator, sensed by the temperature sensor, is equal to or greater than 7° C. and turns off the UV lamp when the temperature of the periphery of the evaporator is less than 7° C., during the automatic mode.

Preferably, the controller turns on the UV lamp again for a certain period of time, when the vehicle engine is turned off after the vehicle operating time exceeds the set time, and then turn off the UV lamp.

Preferably, the apparatus further includes: an optical sensor for sensing whether the UV lamp is turned on, the optical sensor being connected to the controller and installed near the UV lamp; and an alarm lamp turned on/off under the control of the controller, so as to indicate whether the UV lamp is turned on according to a signal input to the controller from the optical sensor.

Preferably, the controller turns on the alarm lamp when the controller inputs a turn-on signal for the UV lamp from the optical sensor in a state where the UV lamp is supplied with power, and turns on/off the UV lamp when the controller inputs a turn-off signal for the UV lamp from the optical sensor in a state where the UV lamp is supplied with power.

Preferably, the optical sensor comprises a photodiode that senses light from the UV lamp and transmits an electrical signal to the controller.

In accordance with another exemplary embodiment of the present invention, the present invention provides a method for controlling an apparatus for sterilizing an evaporator of an automotive HVAC system that has a UV lamp situated at the periphery of the evaporator and a temperature sensor, according to whether vehicle engine starts. The method includes: a vehicle engine start determining step of determining whether the vehicle engine starts; a lamp first operating step of operating a timer to check the vehicle operating time when the vehicle engine starts and turning on the UV lamp to sterilize the evaporator first; a vehicle operating time determining step of continuously turning on the UV lamp until the vehicle operating time exceeds a set time after the lamp first operating step; and a operating mode determining step of determining whether an automatic mode is performed or a continuous mode is performed if the vehicle operating time has exceeded the set time determined at the vehicle operating time determining step, wherein the automatic mode is set to turn on/off the UV lamp, according to temperature changes of the surface of the evaporator sensed by the temperature sensor, and the continuous mode is set to continuously turn on the UV lamp according to temperature changes of the surface of the evaporator, sensed by the temperature sensor.

Here, if the operating mode determining step is determined as the automatic mode, the method further includes: a first temperature sensing step of sensing the temperature of the evaporator through the temperature sensor; a first temperature determining step of determining whether the temperature of the evaporator, sensed in the first temperature sensing step, is equal to or greater than 7° C.; a lamp turning-off step of turning off the UV lamp and returning to the first temperature sensing step if the first temperature determining step concludes that the temperature of the evaporator is less than 7° C.; and a lamp second operating step of continuously turning on the UV lamp if the first temperature determining step concludes that the temperature of the evaporator is equal to or greater than 7° C.

Preferably, the method further includes: a second temperature sensing step of sensing the temperature of the evaporator through the temperature sensor while the lamp second operating step is performed; a second temperature determining step of determining whether the temperature of the evaporator is less than 5° C. after the second temperature sensing step. Here, the lamp's second operating step is performed if the temperature of the evaporator is equal to or greater than 5° C. Also, the lamp's turn-off step is performed and the first temperature sensing step is then performed, if the temperature of the evaporator is less than 5° C.

Preferably, the method further includes: a lamp's third operation step of turning on the UV lamp for an additional set period of time and then turning it off if the vehicle engine is turned off during the automatic mode after the operation mode determining step.

Here, if the operating mode determining step is determined as the continuous mode, the method further includes: a lamp turn-on maintaining step of continuously turning on the UV lamp at the lamp first operation step; a vehicle engine turn-off determining step of determining whether the vehicle engine is turned off after the lamp turn-on maintaining step; performing the lamp turn-on maintaining step if the vehicle engine turn-off determining step concludes that the vehicle engine is turned on; and a lamp additional operating step of turning on the UV lamp for an additional set period of time and then turning it off.

### Advantageous Effects

As described above, the apparatus for sterilizing an evaporator of an automotive HVAC system and the control method thereof, according to the present invention, can control the UV lamp in an automatic-control method using a controller and sterilize the evaporator on which mold and bacteria may multiply or grow, so that sterilized air can be supplied to the passenger compartment. Here, the sterilizing apparatus and the control method thereof can efficiently control the UV lamp according to the temperature conditions of the evaporator.

Furthermore, the apparatus for sterilizing an evaporator of an automotive HVAC system and the control method thereof can indicate whether the UV lamp is operating correctly or is malfunctioning, through an alarm lamp, thereby enhancing the reliability and also informing users when the UV lamp needs replacing.

In addition, the sterilizing apparatus according to the present invention can be used in conjunction with the control devices of automotive HVAC systems.

### BRIEF DESCRIPTION OF THE DRAWINGS

The features and advantages of the present invention will be more apparent from the following detailed description in conjunction with the accompanying drawings, in which:

FIG. 1 is a schematic view depicting an automotive heating, ventilating, and air-conditioning (HVAC) system adapted to the present invention;

FIG. 2 is a schematic circuit block diagram illustrating an apparatus for sterilizing an evaporator of an automotive HVAC system according to the present invention; and

FIG. 3 is a flow chart describing a control method of the apparatus for sterilizing an evaporator of an automotive HVAC system. according to the present invention.

### BRIEF DESCRIPTION OF SYMBOLS IN THE DRAWINGS

30: outlet duct

50: evaporator

100: sterilizing apparatus

110: controller

120: oscillation transformer

130: UV lamp

140: temperature sensor

150: mode selection switch

160: engine start detector

170: timer

180: display unit

181: alarm lamp

190: optical sensor

### BEST MODE FOR CARRYING OUT THE INVENTION

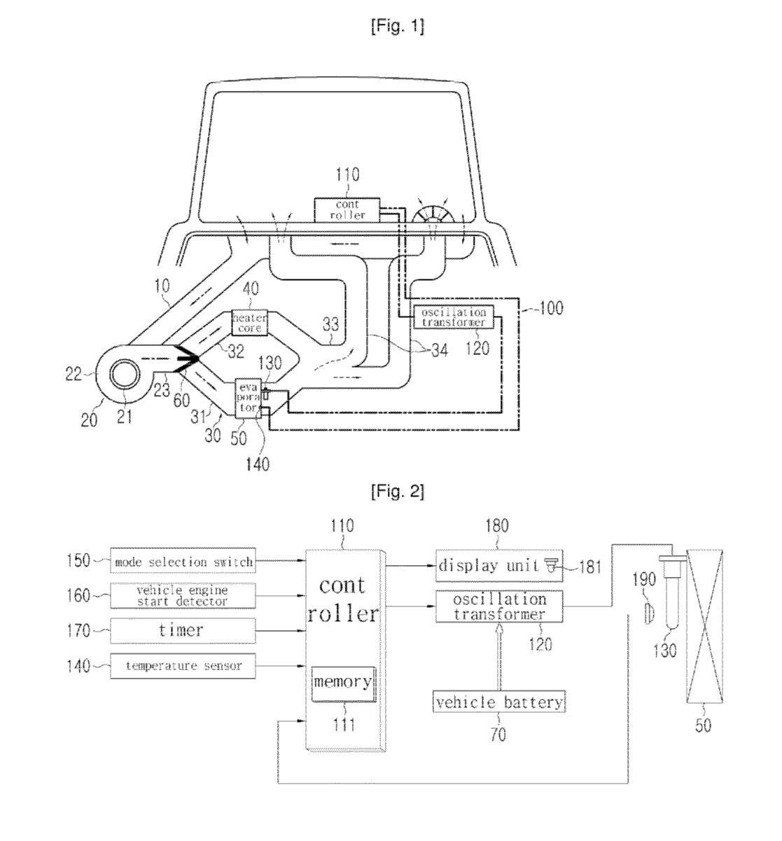

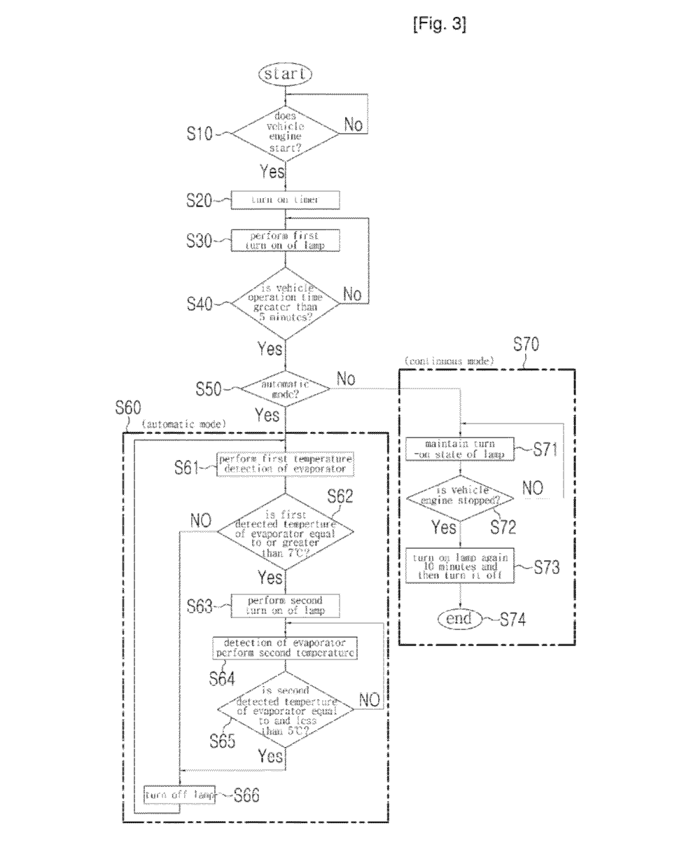

Now, preferred embodiments of the present invention will be described in detail with reference to the accompanying drawings. FIG. 1 is a schematic view depicting an automotive heating, ventilating, and air-conditioning (HVAC) system adapted to the present invention. FIG. 2 is a schematic circuit block diagram illustrating an apparatus for sterilizing an evaporator of an automotive HVAC system according to the present invention. FIG. 3 is a flow chart describing a control method of the apparatus for sterilizing an evaporator of an automotive HVAC system, according to the present invention.

As shown in FIG. 1, the automotive HVAC system includes: an inlet duct 10 located within an engine room for receiving air from the outside or inside; a blower unit 20 in flow communication with the inlet duct 10; an outlet duct 30 for directing a flow of air from the blower unit 20 to a passenger compartment; and a heater core 40 and an evaporator 50, which are located within the outlet duct 30.

The blower unit 20 includes a motor 21 and a blower 22. The motor 21 is controlled by a cooling/heating switch (not shown) located inside the passenger compartment. The outlet duct 30 is in flow communication with the outlet of the blower 22 and with the passenger compartment. The outlet duct 30 is configured in such a way that it is divided into two branches at the blowing outlet 23, i.e., a cooling duct 31 and a heating duct 32, and then the cooling duct 31 and heating duct 32 are join together to form a united duct 33. Also, the outlet duct 30 includes distributing ducts 34 for distributing a flow of air to the passenger compartment.

The heater core 40, operated at a heating mode, is located within the heating duct 32. The evaporator 50 included in the refrigerant circuit system is located within the cooling duct 31. The air output from the blowing outlet 23 becomes either heated air or cooled air depending on whether it passes through the heater core 40 or the evaporator 50, so that heated or cooled air is supplied to the passenger compartment. The selection of the heating mode or the cooling mode is performed according to whether a hinge door 60 is opened or closed under the control of a manipulating device (not shown) located in the passenger compartment.

When the refrigerant circuit system is operated, the evaporator 50 forms water droplets on its surface in the process of heat exchange. The wet surface of the evaporator 50 allows foreign matters to adhere to the surface and this causes mold and bacteria to multiply and grow.

The present invention is directed to prevent mold and bacteria, etc. from multiplying and growing on the surface of the evaporator 50 included in the refrigerant circuit system, thereby exerting the sterilization and deodorization processes.

Referring to FIG. 1 and FIG. 2, the apparatus for sterilizing an evaporator of an automotive HVAC system 100, according to the present invention, is hereinafter referred to as a sterilizing apparatus. The sterilizing apparatus 100 is supplied with power output from a vehicle battery 70. That is, when the vehicle starts, the sterilizing apparatus 100 sterilizes the evaporator 50 either periodically or continuously.

The sterilizing apparatus 100 includes: an engine start detector 160 for detecting whether the vehicle engine has started up; a timer 170 for measuring vehicle operating time; a temperature sensor 140 for sensing the temperature of the evaporator 50; a mode selection switch 150 for setting a sterilizing mode; an ultraviolet (UV) lamp 130 installed to the periphery of the evaporator 50; an oscillation transformer 120 for supplying power to the UV lamp 130; an optical sensor 190 for sensing whether the UV lamp 130 is turned on; and a controller 110 for controlling the oscillation transformer 120 so that the UV lamp 130 can turn on/off, periodically or continuously, to perform a sterilizing process. The respective parts are described in detail below.

The engine start detector 160 is connected to the controller 110, and detects whether the vehicle starts as the engine start detector 160 is connected to the power line of the key box, ignition-1 (IG-1), when the start key is turned to the ON position. The operation principle of the engine start detector 160 is perceived from the engine start process where electric current flows from the vehicle battery 70 to the power line (IG-1) when the start key is positioned at the ON position and does not flow from the vehicle battery 80 to the power line (IG-1) when the start key is positioned at the OFF position. The engine start detector 160 can be electrically connected to the power line (IG-1) without modifying the compartment of electronic equipment for vehicles.

The timer 170 is connected to the controller 110. The timer 170 measures the vehicle operating time from the point in time when the engine start detector 160 detects the vehicle starting. That is, when the controller 110 inputs the detection signal of the engine start detector 160, the timer 170 operates to measure the vehicle operating time.

The ultraviolet (UV) lamp 130 is situated in the vicinity of the evaporator 50, located within the cooling duct 31, and sterilizes the evaporator 50. The UV lamp 130 is operated by high voltage to which the oscillation transformer 120 converts 12 Volt DC supplied from the vehicle battery 70. The UV lamp 130 emits UV light of approximately 180˜450 nm which is a sufficient to sterilize the surface of the evaporator 50 and to decompose various organic matters in the air flowing through the cooling duct 31. The sterilizing process will be described in detail later.

The optical sensor 190 serves to sense whether the UV lamp 130 is turned on. In an embodiment of the present invention, the optical sensor 190 is implemented by a photodiode that detects light emitted from the UV lamp 130 and transmits an electrical signal to the controller 110. It is preferable that the optical sensor 190 is installed near the UV lamp 130 to easily sense the light from the UV lamp 130. When the UV lamp 130 is turned on, the optical sensor 190 senses the light emitted from the UV lamp 130 and transmits an electrical signal converted from the emitted light to the controller 110. On the contrary, when the UV lamp 130 is turned off, the optical sensor 190 transmits to the controller 110 a signal indicating that the UV lamp 190 is turned off. The controller 110 controls the turning on/off of an alarm lamp 181, which will be described later, according to the input signal from the optical sensor 190. The embodiment of the present invention is implemented in such a way that the optical sensor 190 (for example, a photodiode) senses whether the UV lamp 130 is turned on/off, however, it should be understood that the detection of turning on/off of the UV lamp 120 can be achieved by other sensing elements, such as an illumination sensor, etc.

The temperature sensor 140 is installed in the vicinity of the evaporator 50 and senses the temperature of the evaporator surface. The temperature sensor 140 senses the temperature of the surface of the evaporator 50 at an automatic mode, which will be described later, and transmits an electrical signal to the controller 110. The controller 110 intermittently turns on/off the UV lamp 130 according to the input electrical signal.

The mode selection switch 150 sets the UV lamp 130 to an automatic mode (step S60 in FIG. 3) or a continuous mode (step 570 in Figure). In the automatic mode, the UV lamp 130 is turned on/off according to the temperature of the surface of the evaporator 50, which is sensed by the temperature sensor 140. In the continuous mode, the UV lamp 130 is continuously turned on. Each time a user manipulates the mode selection switch 150, it is operated to alternate between the automatic mode and the continuous mode, which is previously programmed into the memory of the controller 110.

After sensing the engine start through the engine start detector 160, the controller 110 controls the turning on/off of the UV lamp 130 according to whether the automatic mode (S60) or the continuous mode (S70) is set by the mode selection switch 150. During the automatic mode of step S60, the controller 110 turns on/off the UV lamp 130 according to temperature changes of the surface of the evaporator 50, sensed by the temperature sensor 140. However, during the continuous mode (S70), the controller 110 continuously turns on the UV lamp 130.

The memory 111 of the controller 110 also stores a program that continuously turns on the UV lamp 130 for a certain period of time, regardless of whether the mode is set or not, to sterilize the evaporator 50 when the vehicle engine starts up. The embodiment of the present invention is implemented in such a way that the UV lamp is continuously turned on for 5 minutes at the beginning and then enters a set mode, so that it can sterilize the evaporator 50 on which mold and bacteria may multiply and grow at a room temperature.

The controller 110 also is connected to a display unit 180 (for example, an LCD) for displaying the operation mode and time. In addition, the controller 110 is connected to an oscillation transformer 120 that is supplied with power from the vehicle battery 70 and supplies high power to the UV lamp 130. Since the oscillation transformer 120 has been described in conjunction with the UV lamp 130, its detailed description will be omitted below.

It is preferable that the display unit 180 is located in the passenger compartment, so that a driver can easily monitor its operating states. The display unit 180 includes an alarm lamp 181 for indicating whether the UV lamp 130 is turned on/off. In an embodiment of the present invention, the alarm lamp 181 is implemented by an LED that is turned on/off according to a signal from the optical sensor 190 to the controller 110. That is, when inputting a signal, indicating that the UV lamp 130 is turned on, from the optical sensor 190 in a state where power is supplied to the UV lamp 130, the controller 110 continuously turns on the alarm lamp 181. On the contrary, when inputting a signal, indicating that the UV lamp 130 is turned off, from the optical sensor 190 even though power is supplied to the UV lamp 130, the controller 110 repeatedly turns on/off the alarm lamp 181. In that case, the controller concludes that the UV lamp 130 has finished its life span or is not operating properly. It is preferable that the display unit 180 including the alarm lamp 181 is installed in the passenger compartment so that a user can easily monitor the state of the system. When power supplied to the UV lamp 130 is interrupted normally, the controller is programmed so that it can turn off the alarm lamp 181 regardless of the input signal of the optical sensor 190.

Through the alarm lamp 181 of the display unit 180 in the passenger compartment, the user can check whether the UV lamp of the sterilizing apparatus 100, located within the vehicle engine room, is operating normally.

In the following description, the control method of the sterilizing apparatus will be explained, according to whether the vehicle starts (operates), with reference to FIG. 3.

First, when a driver turns the key of a vehicle to the ON position, the controller determines whether the vehicle engine starts through the engine start detector 160 (S10).

When concluding that the vehicle engine starts at step S10, the controller 110 operates the timer 170 to acquire vehicle operating time information (S20). After that, the controller 110 enables the UV lamp 130 to perform the lamp's first operation process (S30), in which the UV lamp 130 serves to sterilize the evaporator 50 that comprises the automotive HVAC system. The UV lamp 130 is supplied with power from the oscillation transformer 120. That is, when the controller 110 concludes that the vehicle engine starts at step S10, it enables the oscillation transformer 120 to receive power from the vehicle battery 70 and to function.

When the UV lamp 130 performs the first operation at step S30, it emits UV light of the wavelength 180˜450 nm, which serves to sterilize bacteria and mold multiplying and growing on the surface of the evaporator 50.

More specifically, when UV light is beamed onto the surface of the evaporator 50, electrons and election holes are formed thereon and accordingly hydroxy radical (—OH) and superoxide which have strong oxidizing powers are formed. The hydroxy radical and superoxide use the process of oxidation to decompose organic compound into water and carbon dioxide. Therefore, when the UV lamp 130 is turned on, potentially harmful matter around the evaporator 50 is converted into harmless water and carbon dioxide. The UV light of the UV lamp 130 can also use the oxidation process to decompose airborne organic compounds, such as bacteria and odor molecules. Therefore, the automotive HVAC system according to the present invention can supply sterilized air to the passenger compartment.

The first operation of the UV lamp of step S30 lasts until the vehicle operating time exceeds a set time. That is, while the first operation of the UV lamp is being performed, the controller 110 determines whether the vehicle operating time is greater than a set time through the timer 170 (S40). When the controller 110 concludes that the vehicle operating time exceeds a set time at step S40, it checks the mode set by the mode selection switch 150 (which is called an operation mode determining step) (S50).

In the embodiment of the present invention, the time is set at 5 minutes. According to the embodiment, after the vehicle engine has started, when the UV lamp 130 turns on for 5 minutes, the UV light from the UV lamp 130 can sterilize the entire surface of the evaporator 50. Although FIG. 3 does not show this, when the vehicle engine is turned off before the operation mode determining step of S50 is completed, the controller 110 is programmed to proceed with the vehicle start determining step of S10. This is because the vehicle operating time is short and thus the degree of potentially harmful substances on the surface of the evaporator 50 is low and because the evaporator 50 has already been sterilized by the UV lamp 130.

When the vehicle operating time exceeds 5 minutes at step S40, the operation mode determining step is performed at step S50. According to the mode set by the mode selection switch 150 at step S50, an automatic mode is performed (S60) or a continuous mode is performed (S70). In the automatic mode, the UV lamp 130 is intermittently turned on/off according to temperature changes in the evaporator 50. In the continuous mode, the UV lamp 130 is continuously turned on.

Regarding the automatic mode of step S60:

When a user sets the automatic mode through the mode selection switch 150, the controller 110 concludes that the operation mode is set to the automatic mode at step S50. The temperature sensor 140 senses the temperature of the evaporator 50 (which is called the first temperature sensing process) (S61). The controller 110 determines whether the temperature of the evaporator 50, sensed in the first temperature sensing process at step S61, is equal to or greater than 7° C. (S62). When the temperature of the evaporator 50, sensed in the first temperature sensing process at step S61, is less than 7° C. at step S62, the controller 110 turns off the UV lamp 130 (S66) and then proceeds with the first temperature sensing process of step S61. On the contrary, when the temperature of the evaporator 50, sensed in the first temperature sensing process at step S61, is equal to or greater than 7° C. at step S62, the controller 110 continuously turns on the UV lamp 130 (which is called a lamp secondary operating process) (S63).

More specifically, in order to achieve a temperature of less than 7° C. for the evaporator 50 as sensed in the first temperature sensing process at step S62, the cooling unit of the automotive HVAC system begins operating within 5 minutes of the vehicle operating time. When the temperature is less than 7° C., bacteria and mold almost cease multiplying and growing. Therefore, the controller 110 turns off the UV lamp at step S66.

In the embodiment of the present invention, 7° C. is selected as the reference temperature of the first temperature determining process of step S62 because it is known that bacteria and mold can multiply and grow at the periphery of the evaporator 50 under temperature conditions equal to or greater than 7° C.

When the temperature sensed in the first temperature process at S62 is equal to or greater than 7° C. the controller 110 continuously operates the UV lamp 130 to performs the lamp secondary operation process at step S63 in which the UV light of the UV lamp 130 can further sterilize the periphery of the evaporator 50. That is, when the temperature of the evaporator 50, sensed in the first temperature process at S62, is equal to or greater than 7° C., the lamp secondary operation process of step S63 is performed in such a way that power is continuously supplied to the UV lamp 130 that has been turned on in the lamp's first operation process of step S61.

After the lamp's second operation process of step S63, the temperature sensor 140 senses the temperature of the evaporator 50, which is called a second temperature sensing process (S64). The controller 110 determines whether the temperature of the evaporator 50, sensed in the second temperature sensing process of step S64, is less than 5° C., which is called the second temperature determining process (S65).

When the temperature of the evaporator 50 is equal to or greater than 5° C. at the second temperature determining process of step S65, the controller 110 returns the procedure to step S64. On the contrary, when the temperature of the evaporator 50 is less than 5° C. at the second temperature determining process of S65, the controller 110 turns off the UV lamp at step S66 and then returns the procedure to step S61. In order to bring the temperature of the evaporator 50 to less than 5° C., as sensed in the second temperature sensing process at step S65, the vehicle operating time should exceeds 5 minutes and the cooling unit of the automotive HVAC system has to be operated for the required time period. Although the evaporator 50 forms many water droplets on the surface thereof, bacteria and mold almost cease to multiply and grow on the evaporator surface at temperatures of less than 7° C. Therefore, the controller 110 turns off the UV lamp at step S66.

When the engine start detector 160 senses that the vehicle engine has stopped during the automatic mode of S60, the controller 110 turns on the UV lamp 130 again for a certain period of time and then turns it off, which is called the lamp's third operation process (not shown in FIG. 3). Such an operation is performed because: when the vehicle operating time exceeds 5 minutes, the evaporator 50 will form many water droplets on the surface thereof; and if the vehicle engine is stopped and the automotive HVAC system is also turned off when the evaporator surface is wet, the wet evaporator surface forms an environment where mold and bacteria can multiply and grow.

When the vehicle engine is stopped after the vehicle operating time exceeds 5 minutes, the UV lamp 130 is turned on again for a certain period of time (10 minutes in an embodiment of the present invention) and is then turned off. That is, while the vehicle engine is stopped, the sterilizing system of the present invention further operates the UV lamp 130 for 10 minutes, so that it can completely sterilize bacteria and mold on the surface of the evaporator 50.

Regarding the continuous mode of step S70:

When a user sets the continuous mode through the mode selection switch 150, the controller 110 concludes that the operation mode is set to the continuous mode at step S50, in which the UV lamp 130 is continuously turned on regardless of the temperature change of the evaporator 50. The controller 110 continuously turns on the UV lamp 130 that has been turned on at the lamp first operation process of step S30, which is called a lamp turn-on maintaining process (S71). After that, the controller 110 determines whether the vehicle engine is stopped through the engine start detector 160, which is called a vehicle engine turn-off determining process (S72). When concluding that the vehicle engine is stopped at step S72, the controller 110 turns on the UV lamp 130 again for a certain period of time and then turns it off, which is called the lamp's additional operation process (S73).

While the engine is operating, the periphery of the evaporator 50 is continuously sterilized during the continuous mode of step S70. When the controller 110 concludes that the vehicle engine starts at the vehicle engine turn-off determining process of step S72, the lamp turn-on maintaining process of step S71 is continuously maintained.

The lamp additional operation process of step S73 is the same as the lamp third operation process of the automatic mode of step S60. When the vehicle engine is stopped after the vehicle operating time exceeds 5 minutes, the UV lamp 130 is turned on for a certain period of time (10 minutes in an embodiment of the present invention) and is then turned off. Therefore, after the vehicle engine is stopped, the sterilizing apparatus of the present invention turns on the UV lamp 130 again for 10 minutes. so that the UV lamp 130 can irradiate UV light to the evaporator 50 and completely sterilize bacteria and mold on the surface of the evaporator 50.

As such, the sterilizing apparatus of the present invention can completely sterilize the periphery of the evaporator 50 before the vehicle operating time exceeds 5 minutes. Also, although the vehicle engine has stopped, the sterilizing apparatus can sterilize the evaporator 50 and the periphery of the evaporator 50. Although the cooling unit is operated immediately after the vehicle engine starts, the sterilizing apparatus can supply fresh air to the passenger compartment. Also, when the automatic mode of step S60 or the continuous mode of step S70 is performed to operate the UV lamp 130 during the vehicle operation, various organic matters, contained in the air flowing through the periphery of the evaporator 50 and the cooling duct 31, are decomposed, so that the air in the passenger compartment is always pleasant and fresh.

When the controller supplies power to the UV lamp 130 through the oscillation transformer regardless of whether it is set to the automatic mode/continuous mode, it can continuously turn on the alarm lamp 181 by inputting the turn-on signal of the UV lamp 130, sensed through the optical sensor 190. Therefore, the vehicle driver can see that the UV lamp 130 is working normally through the continuously turned on the alarm lamp 181. On the contrary, although power is supplied to the UV lamp 130 regardless of the automatic mode/continuous mode, when the UV lamp 130 does not irradiate and thus a turn-off signal of the UV lamp 130 is input to the controller 110, the controller 110 repeatedly turns on/off of the alarm lamp 181. In that case, the vehicle driver can see that the UV lamp 130 has finished its life span or has malfunctioned, and then take necessary action, such as replacing the UV lamp 130.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention can be widely applied to the application fields related to sterilizers including the sterilizing apparatus in which the evaporators of automotive HVAC systems can be sterilized using a UV lamp and thus purified air can be supplied to the passenger compartment.

1. An apparatus for sterilizing an evaporator of an automotive heating, ventilating and air-conditioning (HVAC) system depending on whether vehicle engine starts, the apparatus comprising:
an engine start detector for detecting whether a vehicle engine starts as the engine start detector is connected to a power line of ignition-1 (IG-1) necessary for the engine start up;
an ultraviolet (UV) lamp that is installed adjacent to the evaporator and supplied with power output from a vehicle battery;
a temperature sensor installed adjacent to the evaporator for sensing the temperature of evaporator;
a mode selection switch for setting an automatic mode in which the UV lamp is turned on/off or a continuous mode in which the UV lamp is continuously turned on, according to the temperature of the evaporator sensed by the temperature sensor; and
a controller for controlling the turn on/off of the UV lamp according to the mode set by the mode selection switch, after the engine start detector detects the vehicle start-up, wherein the controller turns on/off the UV lamp according to temperature changes of the surface of the evaporator, sensed by the temperature sensor, when the mode is set to the automatic mode, and continuously turns on the UV lamp when the mode is set to the continuous mode.

2. The apparatus according to claim 1, further comprising:
a timer for measuring the vehicle operating time when the engine start detector detects the engine starting,
wherein the controller turns on the UV lamp for a set time with operation of the timer, and turns on/off the UV lamp according to the mode set by the mode selection switch after the set time has elapsed.

3. The apparatus according to claim 1, wherein the controller continuously turns on the UV lamp when the temperature of the periphery of the evaporator, sensed by the temperature sensor, is equal to or greater than 7° C. and turns off the UV lamp when the temperature of the periphery of the evaporator is less than 7° C., during the automatic mode.

4. The apparatus according to claim 2, wherein the controller turns on the UV lamp again for a certain period of time, when the vehicle engine is turned off after the vehicle operating time exceeds the set time, and then turn off the UV lamp.

5. The apparatus according to claim 1, further comprising:
an optical sensor for sensing whether the UV lamp is turned on, the optical sensor being connected to the controller and installed near the UV lamp; and
an alarm lamp turned on/off under the control of the controller, so as to indicate whether the UV lamp is turned on according to a signal input to the controller from the optical sensor.

6. The apparatus according to claim 5, wherein the controller turns on the alarm lamp when the controller inputs a turn-on signal for the UV lamp from the optical sensor in a state where the UV lamp is supplied with power, and turns on/off the UV lamp when the controller inputs a turn-off signal for the UV lamp from the optical sensor in a state where the UV lamp is supplied with power.

7. The apparatus according to claim 5, wherein the optical sensor comprises a photodiode that senses light from the UV lamp and transmits an electrical signal to the controller.

8. A method for controlling an apparatus for sterilizing an evaporator of an automotive HVAC system that has a UV lamp situated at the periphery of the evaporator and a temperature sensor, according to whether vehicle engine starts, the method comprising:
a vehicle engine start determining step of determining whether the vehicle engine starts;
a lamp first operating step of operating a timer to check the vehicle operating time when the vehicle engine starts and turning on the UV lamp to sterilize the evaporator first;
a vehicle operating time determining step of continuously turning on the UV lamp until the vehicle operating time exceeds a set time after the lamp first operating step; and
a operating mode determining step of determining whether an automatic mode is performed or a continuous mode is performed if the vehicle operating time has exceeded the set time determined at the vehicle operating time determining step, wherein the automatic mode is set to turn on/off the UV lamp, according to temperature changes of the surface of the evaporator sensed by the temperature sensor, and the continuous mode is set to continuously turn on the UV lamp according to temperature changes of the surface of the evaporator, sensed by the temperature sensor.

9. The method according to claim 8, wherein, if the operating mode determining step is determined as the automatic mode, the method further comprises:
a first temperature sensing step of sensing the temperature of the evaporator through the temperature sensor;
a first temperature determining step of determining whether the temperature of the evaporator, sensed in the first temperature sensing step, is equal to or greater than 7° C.;
a lamp turning-off step of turning off the UV lamp and returning to the first temperature sensing step if the first temperature determining step concludes that the temperature of the evaporator is less than 7° C.; and
a lamp second operating step of continuously turning on the UV lamp if the first temperature determining step concludes that the temperature of the evaporator is equal to or greater than 7° C.

10. The method according to claim 9, further comprising:
a second temperature sensing step of sensing the temperature of the evaporator through the temperature sensor while the lamp second operating step is performed;
a second temperature determining step of determining whether the temperature of the evaporator is less than 5° C. after the second temperature sensing step,
wherein: the lamp's second operating step is performed if the temperature of the evaporator is equal to or greater than 5° C.; and the lamp's turn-off step is performed and the first temperature sensing step is then performed, if the temperature of the evaporator is less than 5° C.

11. The method according to claim 8, further comprising:
a lamp's third operation step of turning on the UV lamp for an additional set period of time and then turning it off if the vehicle engine is turned off during the automatic mode after the operation mode determining step.

12. The method according to claim 8, wherein, if the operating mode determining step is determined as the continuous mode, the method further comprises:
a lamp turn-on maintaining step of continuously turning on the UV lamp at the lamp first operation step;
a vehicle engine turn-off determining step of determining whether the vehicle engine is turned off after the lamp turn-on maintaining step;
performing the lamp turn-on maintaining step if the vehicle engine turn-off determining step concludes that the vehicle engine is turned on; and
a lamp additional operating step of turning on the UV lamp for an additional set period of time and then turning it off.
